(19) United States
(12) Patent Application Publication
(10) Pub. No.: US 2016/0140478 A1
(43) Pub. Date: May 19, 2016

(54) ADAPTIVE TASK ASSIGNMENT TO IMPROVE SKILL GROWTH AND BALANCE SERVICE LEVEL AGREEMENTS

(71) Applicant: International Business Machines Corporation, Armonk, NY (US)

(72) Inventors: Geoffrey M. Hambrick, Round Rock, TX (US); Govinda Kamtamneni, Foothill Ranch, CA (US)

(21) Appl. No.: 14/540,643

(22) Filed: Nov. 13, 2014

(51) Int. Cl. G06Q 10/06

(52) U.S. Cl. CPC G06Q 10/063112; G06Q 10/063118

(57) ABSTRACT

Methods and systems may provide for computing the complexities of tasks in a business process management system based on business and process data, and previous durations taken to compute similar tasks. The system and method may also categorize the skill level of one or more users based on user history and other metadata, and use the skill level and task complexity to correlate a task with one or more users that are suitable to complete the task within a related service level agreement. Tasks may be adaptively assigned to users in order to ensure that the tasks are completed as required by the SLA, assigned to less skilled users to improve their skills, and/or dynamically reassigned to ensure that the requirements of the SLA are met. Additionally, the system and method may also be used to manually configure complexities of a task and tag users based on skill level.

### BACKGROUND

Embodiments of the present invention generally relate to the assignment of tasks in a business process management (BPM) system. More particularly, embodiments relate to the adaptive assignment of tasks in a BPM system based on complexities of tasks and skills of users.

BPM solutions may provide the ability to assign tasks to a user or a group of users such as a team for completion. Current BPM solutions typically provide the ability to assign tasks to a user or a team by distributing the tasks via a round robin or load balanced method. It is generally accepted that not all users working on human task(s) will have the same skills to complete a task within the most optimal service level agreements (SLAs), and also, that not all tasks will have the same complexities and data to conform to generic SLA durations. For example, a user that is more familiar with the business data and/or completion scenario of a particular task, may handle the task with minimal effort and time. In this scenario, the user may therefore meet or exceed the SLAs defined for that task. Current solutions, however, do not account for task complexities and the skill level of the user(s), and therefore provide an inefficient distribution of tasks. Other attempts to distribute tasks based on user skill level include, for example, developing ad hoc code and manual processes based on client requirements, and assigning the task(s) to either a user or list of users having a suitable skill level. There remains, however, considerable room for improvement with respect to automation of task assignment/distribution and user skill improvement.

### BRIEF SUMMARY

Embodiments may include a method of adaptively assigning tasks, including computing the complexity of one or more tasks, wherein the complexity is to be based on business data and other process data, categorizing a skill level of one or more users, wherein the skill level is to be based on a history and metadata associated with the user, correlating the one or more tasks with one or more users, and adaptively assigning the one or more tasks to the one or more users, wherein the one or more users are to complete the task in a manner compliant with an associated service level agreement.

Embodiments may also include a computer program product to adaptively assign tasks, the computer program product including computer readable storage medium having program instructions embodied therewith, the program instructions executable by a processor to cause a computer to compute the complexity of one or more tasks, wherein the complexity is to be based on business data and other process data, categorize a skill level of one or more users, wherein the skill level is to be based on a history and metadata associated with the user, correlate the one or more tasks with one or more users, and adaptively assign the one or more tasks to the one or more users, wherein the one or more users are to complete the task in a manner compliant with an associated service level agreement.

Embodiments may also include a computer readable storage medium to adaptively assign tasks, the computer readable storage medium including a set of instructions, which, if executed by a processor, cause a computer to compute the complexity of one or more tasks, wherein the complexity is to be based on business and process data, categorize a skill level of one or more users, wherein the skill level is to be based on a history and metadata associated with the user, correlate the one or more tasks with one or more users, and adaptively assign the one or more tasks to the one or more users, wherein the one or more users are to complete the task in a manner compliant with an associated service level agreement, and the assignment of the one or more tasks is to improve the skill level of the one or more users.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a task assignment system according to an embodiment;

FIG. 2 is a block diagram of an example of a task assignment system and associated normal and adaptive assignment correlation tables; and

FIG. 3 is a flowchart of an example of a method of assigning tasks according to an embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

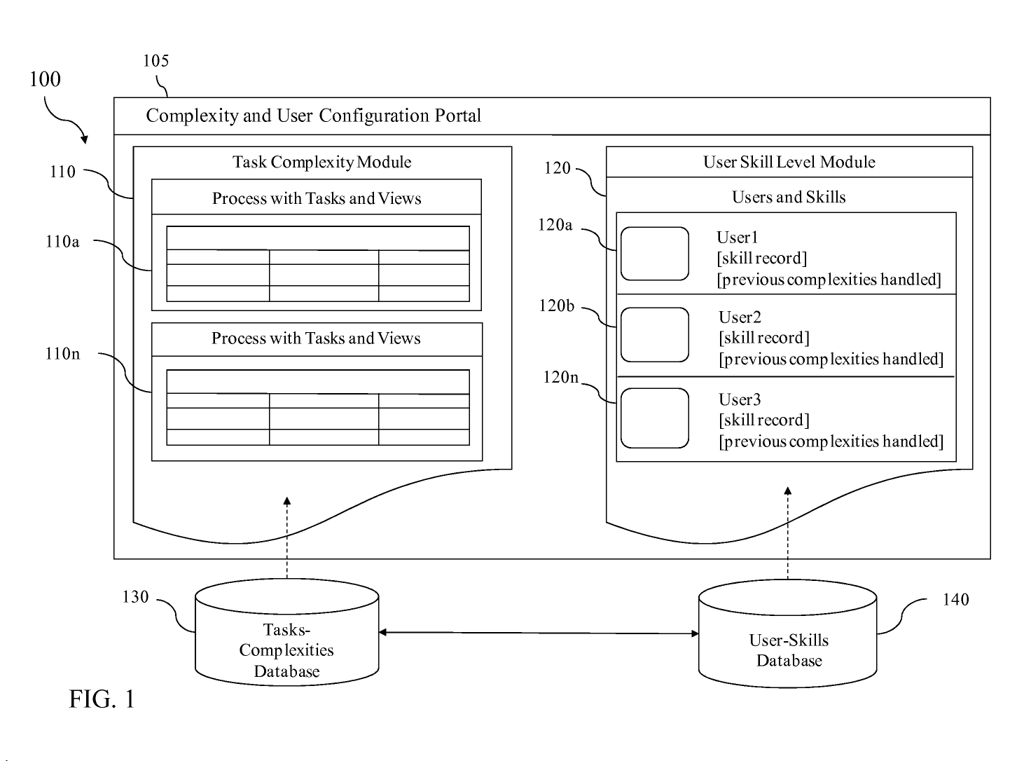

Turning now to FIG. 1, a task assignment system 100 is shown including a task complexity module 110 and a user skill level module 120. In the illustrated example, the task assignment system 100 may include a task assignment engine 105 (depicted as a complexity and user configuration portal) may be configured to compute the complexity of tasks in a business process management (BPM) system and the skill level of users associated with the BPM system, and to adaptively assign tasks to be completed by one or more users based on the skill level of the users. In the illustrated example, the task assignment engine 105 may receive input from associated databases including, for example, a task complexities database 130 and a user skills database 140. In the illustrated example, the task complexities database 130 may include a list of all tasks and the corresponding task complexities for all tasks associated with the BPM system. In the illustrated example, the user skills database 140 may include a list of all users and the corresponding skills for all users associated with the BPM system.

The illustrated task assignment engine 105 may also include task complexity module 110 having one or more process-tasks pairings 110a-110n. In the illustrated example, each of the process-tasks pairings 110a-110n includes an identified process and associated tasks required to complete the process. The process-tasks pairings 110a-110n may also include an associated user skill level required to complete the tasks. The tasks may be identified, for example, by tags or other similar identifiers that allow the task assignment engine 105 to automatically assess the information included in the process-tasks pairings 110a-110n in order to compute the complexity of the one or more tasks, categorize the skill level of one or more users, and correlate the one or more tasks with one or more users. In at least some embodiments, the task assignment engine 105 may continually update the process-tasks pairings 110a-110n based at least in part on the observed skill level of users and the associated complexities of the tasks. The process-tasks pairings 110a-110n may be displayed in various layouts including, for example, a grid, a list, and the like, that are arranged to adaptively display the processes, tasks and user skill levels required for each process of a BPM. The various layouts may enable the process-tasks pairings 110a-110n to be more flexibly viewed, manipulated (including manually configuring the data and associated tags), and updated.

The illustrated task assignment engine 105 may further include user skill module 120 having one or more user profiles 120a-120n. In the illustrated example, each of the user profiles 120a-120n includes criteria associated with a user. The criteria may include, for example, the skill level of the user, user proficiencies, and the complexities of previously completed tasks. The criteria may also include other data including, for example, endorsements, accreditations, degrees, and the like. In the illustrated example, the task assignment engine 105 may compute the complexities of the tasks in an associated BPM system based on business and process data (i.e., metadata) including, for example, user history and previous durations taken to compute similar tasks. The task assignment engine 105 may also categorize the skill level of one or more users based on user history and other metadata associated with the user(s), and use the skill level and task complexity to correlate a task with one or more users that are suitable to complete the task within a related service level agreement. The task assignment engine 105 may also be used to manually configure the complexities of task(s) and tag user profiles 120a-120n of the one or more users based on skill level.

As illustrated in FIG. 1, the process-tasks pairings 110a-110n may be correlated to one or more users 120a-120n having an appropriate user skill level to complete the tasks. The process-tasks pairings 110a-110n may also be reassigned to one or more users 120a-120n such that the tasks are completed within the specified SLA associated with the BPM. The process-tasks pairings 110a-110n may be reassigned to improve the skill level of the one or more users. For example, the task assignment engine 105 may adaptively reassign at least some of the more complex tasks to less skilled users during non-peak times in an effort to allow the less skilled users to develop their skills during less critical times. Similarly, the task assignment engine 105 may also dynamically reassign at least some of the one or more tasks to ensure that the SLA of all tasks are met.

Further, the task assignment engine 105 may allow the manual configuration of the complexity of the tasks and/or user skill levels, for example, via tags entered into the task complexity module 110 and user profiles by means of an input device. In at least some embodiments, the task assignment engine 105 may generate one or more complexity scores for the tasks and one or more skill level scores for the user skill levels. The complexity scores and skill level scores may include, for example, a numerical score (e.g., 1-100, 1-5, etc.) or a proficiency rating (e.g., deficient, novice, proficient, expert, etc.), and the skill level scores may be correlated to particular proficiency ratings based on settings and/or preferences. In at least some embodiments, the tasks assignment engine 105 may utilize the complexity scores and the skill level scores to correlate the process-task pairings 110a-n (based on the one or more included tasks) with the one or more users 120a-n (having an appropriate skill set based on the skills required for the completion of the process-tasks pairings 110a-n) in order to perform the assignment of tasks required to complete a business process.

For example, certain tasks may require users having particular skill level scores or proficiency ratings. The task assignment engine 105 may thereby allow the tasks required to satisfy a business process to be assigned based on either a normal or adaptive assignment, as discussed in more detail below. As a result, the adaptive nature of the task assignment engine 105 allows the system to both improve the skills of users and increase overall productivity and quality.

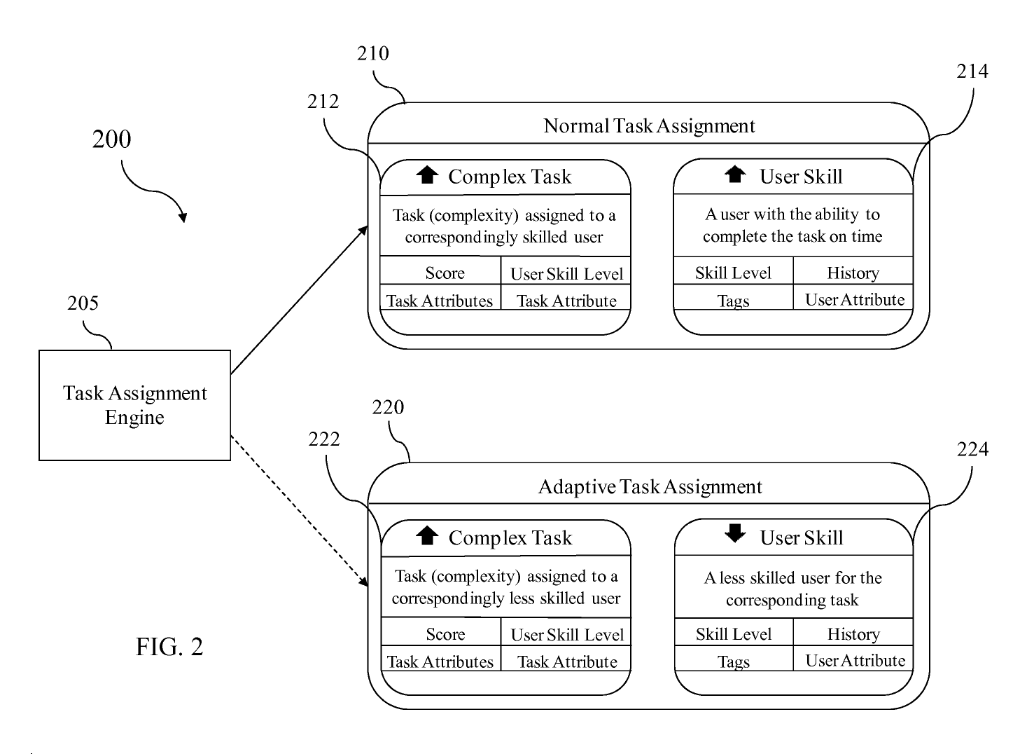

FIG. 2 shows a task assignment system 200 that may be used to assign tasks in accordance with the present disclosure. A more detailed view of the task assignment system 200 is shown in FIG. 1 (task assignment system 100). In the illustrated embodiment, the task assignment engine 205 may perform the assignment of tasks based on a “normal” assignment or an “adaptive” assignment. A first task assignment 210 represents a normal assignment of tasks, i.e., normal task assignment, by the task assignment engine 205. A second task assignment 212 represents an adaptive assignment of tasks, i.e., adaptive task assignment, by the task assignment engine 205.

In the illustrated embodiment, the normal task assignment 210 may include a process-tasks pairing 212 and an assigned user profile 214. The process-tasks pairing 212 may contain various data related to the business process and tasks required to complete one or more tasks including, for example, an overall task complexity rating (e.g., high, moderate, low, complex, simple, etc.), complexity score, required user skill level, task attributes, and the like. The user profile 214 may contain various data related to the user skill and proficiencies required to complete the one or more tasks including, for example, an overall user skill rating (e.g., high, moderate, low, etc.), skill level, tags, user history, user attributes, and the like. The process-tasks pairing 212 of the normal task assignment 210 may be generated to assign the tasks to a user having skills sufficient to complete the tasks on time and in compliance with an associated SLA.

Similarly, in the illustrated embodiment, the adaptive task assignment 220 may include a process-tasks pairing 222 and a user profile 224. The process-tasks pairing 222 may include similar information as included in process-tasks pairing 212 of normal task assignment 210. However, the process-tasks pairing 222 of the adaptive task assignment 220 may be generated to assign the tasks to a user not having sufficient skills to complete the tasks on time and in compliance with an associated SLA, i.e., the task complexity may be slightly higher than the ability of the user to complete the task as required. The adaptive task assignment 220 may thereby allow the assigned user to improve the skills required to complete the task. However, because the adaptive task assignments, such as adaptive task assignment 220, may be generally made during non-peak (i.e., low volume) times, the demand to quickly complete the assigned tasks is diminished and the users may be afforded the opportunity to improve the associated skill sets required to complete the tasks while remaining compliant with the requirements of an associated SLA.

Further, in the illustrated embodiment, the task assignment engine 205 in addition to the adaptive assignment of tasks may also optionally provide a dynamic reassignment of tasks via, for example, the adaptive task assignment 220. The dynamic reassignment of at least some of the one or more tasks, e.g., the tasks included in process-tasks pairing 212 and/or process-tasks pairing 222, may help ensure that the service level agreements of all tasks are met. For example, if the task assignment engine 205 detects that one or more tasks are at risks of not meeting the requirements of a SLA (e.g., not being completed on time or at a specified level of service), the task reassignment engine 205 may dynamically reassign the tasks to new users to ensure that the SLAs are met. The task reassignment engine 205 may also make record of the dynamic reassignment to ensure that the user skill level(s) and task complexities may be correspondingly adjusted, as appropriate.

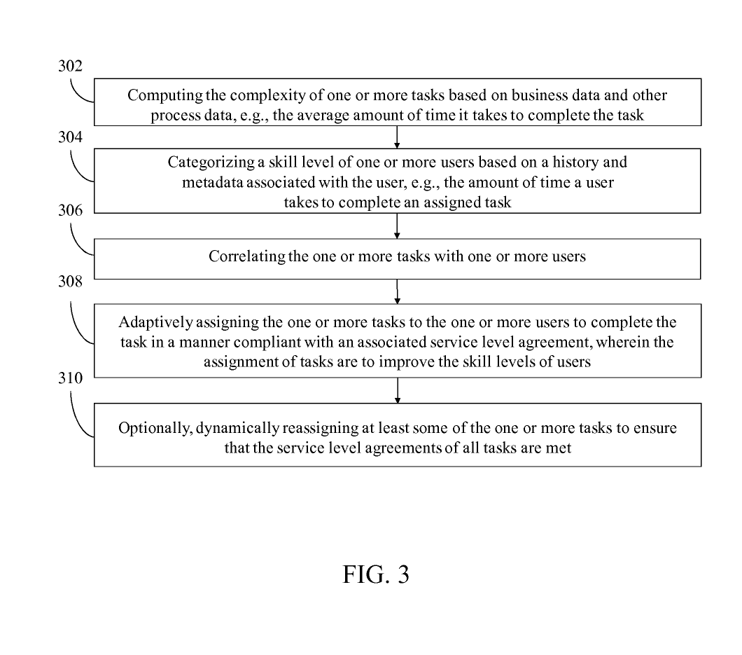

Turning now to FIG. 3, a method of adaptively assigning tasks is shown. The method 300 may be implemented in a business process machine (BPM) such as, for example, one or more of the task assignment system 100 (FIG. 1), already discussed. Illustrated processing block 302 may compute the complexity of one or more tasks. The complexity may be based on business data and other processing data, as discussed more thoroughly above. Illustrated processing block 304 may categorize a skill level of one or more users. The skill level may be based on a history and metadata associated with the user. Illustrated processing block 306 may correlate the one or more users. Illustrated processing block 308 may adaptively assign the one or more task to the one or more users. The one or more users are to complete the task in a manner compliant with an associated SLA. Illustrated processing block 310 may, optionally, dynamically reassign at least some of the one or more tasks to ensure that the SLAs of all tasks are met. The dynamic reassignment of tasks helps to ensure that tasks that are at risk of not meeting an SLA may be reassigned to ensure that the SLA is met. As a result, the illustrated method provides user(s) the opportunity to improve the skill sets required to complete assigned tasks while remaining compliant with the requirements of an associated SLA.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A computer program product to adaptively assign tasks, the computer program product comprising computer readable storage medium having program instructions embodied therewith, the program instructions executable by a processor to cause a computer to:
compute the complexity of one or more tasks, wherein the complexity is to be based on business data and other process data;
categorize a skill level of one or more users, wherein the skill level is to be based on a history and metadata associated with the user;
correlate the one or more tasks with one or more users; and
adaptively assign the one or more tasks to the one or more users, wherein the one or more users are to complete the task in a manner compliant with an associated service level agreement.

2. The computer program product of claim 1, wherein the assignment of the one or more tasks is to improve the skill level of the one or more users.

3. The computer program product of claim 2, wherein the computer usable code, if executed, further causes a computer to:
adaptively reassign relatively complex tasks to less skilled users during non-peak times.

4. The computer program product of claim 3, wherein the computer usable code, if executed, further causes a computer to:
dynamically reassign at least some of the one or more tasks to ensure that the service level agreements of all tasks are met.

5. The computer program product of claim 1, wherein the computer usable code, if executed, further causes a computer to:
allow manual configuration of the complexity of the one or more tasks and user tags.

6. The computer program product of claim 1, wherein the complexity includes a complexity score, and the skill level includes a skill level score.

7. The computer program product of claim 6, wherein the complexity score and the skill level are utilized to correlate the one or more tasks with the one or more users.

8-14. (canceled)

15. A computer readable storage medium to adaptively assign tasks, the computer readable storage medium comprising a set of instructions, which, if executed by a processor, cause a computer to:
compute the complexity of one or more tasks, wherein the complexity is to be based on business and process data;
categorize a skill level of one or more users, wherein the skill level is to be based on a history and metadata associated with the user;
correlate the one or more tasks with one or more users; and
adaptively assign the one or more tasks to the one or more users, wherein the one or more users are to complete the task in a manner compliant with an associated service level agreement, and the assignment of the one or more tasks is to improve the skill level of the one or more users.

16. The computer readable storage medium of claim 15, wherein the business and process data includes data attributes, previous task durations, and user skill levels.

17. The computer readable storage medium of claim 16, wherein the computer usable code, if executed, further causes a computer to:
adaptively reassign relatively complex tasks to less skilled users during non-peak times.

18. The computer readable storage medium of claim 17, wherein the computer usable code, if executed, further causes a computer to:
dynamically reassign at least some of the one or more tasks to ensure that the service level agreements of all tasks are met.

19. The computer program product of claim 15, wherein the computer usable code, if executed, further causes a computer to:
allow manual configuration of the complexity of the one or more tasks and user tags.

20. The computer readable storage medium of claim 15, wherein the complexity includes a complexity score, and the skill level includes a skill level score, and the complexity score and the skill level are utilized to correlate the one or more tasks with the one or more users.
